(19) United States
(12) Patent Application Publication
(10) Pub. No.: US 2025/0150175 A1
(43) Pub. Date: May 8, 2025

(54) Optical Transceiver With Integrated Dispersion Compensation For High Bit Rate Applications

(71) Applicant: II-VI Delaware, Inc., Wilmington, DE (US)

(72) Inventor: Giovanni Barbarossa, Saratoga, CA (US)

(73) Assignee: II-VI Delaware, Inc., Wilmington, DE (US)

(21) Appl. No.: 18/837,711

(22) PCT Filed: Mar. 7, 2023
(86) PCT No.: PCT/US2023/014681

§ 371 Date: Aug. 12, 2024

Related U.S. Application Data
(60) Provisional application No. 63/317,606, filed on Mar. 8, 2022.

(51) Int. Cl. H04B 10/61; H04B 10/40

(52) U.S. Cl. CPC H04B 10/6161; H04B 10/40

(57) ABSTRACT

An optical configuration for providing chromatic dispersion compensation in a high data rate communication system is based upon using optical dispersion compensation in the receive signal path prior to performing an O/E conversion. The performance of chromatic dispersion compensation in the optical domain thus presents a “corrected” optical signal as an input to the photodetecting device. The inclusion of optical-based chromatic dispersion compensation allows for a higher data rate to be used without introducing an unacceptable bit error rate; alternatively, the use of optical-based dispersion correction allows for the reach of a data communications network to be increased.

### CROSS-REFERENCE TO RELATED APPLICATIONS

This application claims priority from U.S. Provisional Application No. 63/317,606, filed Mar. 8, 2022 and herein incorporated by reference.

### TECHNICAL FIELD

Disclosed herein is an arrangement for providing chromatic dispersion compensation at an optical receiver within a high speed data network and, more particularly, to an optical-based compensation that mitigates the effects of dispersion prior to performing optical/electrical conversion of the received signal.

### BACKGROUND OF THE DISCLOSURE

Chromatic dispersion in optical communication systems can be thought of as the pulse broadening that occurs as a transmitted signal propagates along an optical fiber signal path. To date, chromatic dispersion has not presented a problem in data communication systems, since the link lengths between the optical transmitter and receiver are relatively short (typically no more than 2 kms) and the supported data rates are relatively low (no greater than 100 Gb/s, for example). However, as the demand for transmission capacity in an optical transceiver advances into the terabit/s realm, line rates for data paths begin to increase to rates such as 400 G/s, entering the range where chromatic dispersion becomes evident in pulses that travel only a few kilometers in these short reach applications.

One approach to compensating for the chromatic dispersion in data communication systems has been to utilize a coherent transmission technique, which compensates for the effects of dispersion on the transmitted pulses but requires complex and expensive electronic circuitry, optical components and a local oscillator at the receiver to properly recover the transmitted data.

### SUMMARY

Disclosed herein is an arrangement for providing chromatic dispersion compensation for an optical receiver operating in a high data rate network and, more particularly, to an optical-based compensation arrangement that corrects for distortions in the optical domain before the incoming optical signal is coupled into the receiver's photodetecting device.

In particular, it is proposed to utilize chromatic dispersion components in the form of GT etalons, ring resonators, VIP, or any other type of optical component that is able to introduce phase shifts that compensate for the pulse broadening experienced by the transmitted high data rate optical signal.

In accordance with the principles of the present disclosure, an increase in transmission capacity (or an extension of the optical path length “reach”) is obtained by the use of optical-based chromatic dispersion compensation without the need to introduce other modifications in the transceiver architecture itself. For example, a transceiver configured to support eight separate channels (lanes) of optical signal paths, each operating at 100 Gb/s (and thus a capacity of 800 G) may be doubled to run at a data rate of 200 Gb/s merely by incorporating chromatic dispersion compensation within the receiver.

Advantageously, the types of optical elements that may be used to perform chromatic dispersion compensation may be integrated with the photodetectors themselves in a photonic integrated circuit, which therefore provides a relatively compact receiver structure.

An exemplary embodiment of the present invention may take the form of an optical receiver for use in a high data rate optical communication network, where the receiver includes an optical-based chromatic dispersion compensation element (responsive to an incoming optical data signal and configured to introduce optical phase delays sufficient to correct for fiber link-related chromatic dispersion), a photodetector for converting the corrected optical data signal into an electrical equivalent, and electronic receiver circuitry coupled to the output of the photodetector for recovering electrical clock and data signals from the corrected optical data signal input.

Other and further examples and embodiments representative of this disclosure will become apparent during the course of the following discussion and by reference to the accompanying drawings.

### BRIEF DESCRIPTION OF THE DRAWINGS

Referring now to the drawings,

FIG. 1 is a simplified block diagram of a typical prior art optical transceiver as used to support data communications within a short reach optical data network;

FIG. 2 illustrates an exemplary optical transceiver formed in accordance with the present disclosure to provide optical-based dispersion compensation at an optical receiver input;

FIG. 3 illustrates an embodiment of a receiver based on the integration of chromatic dispersion compensation elements with a photodiode array;

FIG. 4 illustrates another disclosed embodiment, where in this case a plurality of tunable chromatic dispersion elements is integrated with a photodiode array;

FIG. 5 illustrates another type of optical transceiver utilizing optical-based chromatic dispersion compensation on the received data signals in accordance with the disclosed teachings; and

FIG. 6 illustrates yet another embodiment of an optical transceiver formed in accordance with the present disclosure, which utilizes the multi-wavelength feature of FIG. 5 in combination with an M-dimensional architecture.

### DETAILED DESCRIPTION

The continued development of services that depend on the ability to transmit large amounts of data (currently reaching the terabit level) presents different challenges than the networks configured to transmit voice and data communications over long distances. In particular, newer services such as data centers, internet of things (IoT), industrial IoT, cloud computing and the like, utilizes only short links of optical fiber from one transceiver to the next (typically no greater than a few kms). In order to provide the desired volume of data transfer from one transceiver to the next, data networks rely on the use of parallel communication paths, typically 4, 8 or 16 paths (at times referred to as “lanes”) to interconnect the transceivers.

The current need to increase the data rate used for these data networks beyond current 100 Gb/s (per lane) has brought with it the introduction of chromatic dispersion along the signal paths. While the links are relatively short (compared to telecommunication span lengths), the ever-increasing data rate has been sufficient to introduce pulse broadening and dispersion to develop between a transmitter and receiver. Prior art solutions have involved using a coherent transmission system (which effectively cancels out the dispersion), but this is at a cost of reduced bandwidth and complex electronics within the receiver.

Instead, as described in detail below, an alternative approach to compensating for chromatic dispersion in an optical data communication system is proposed. In particular, it is proposed to incorporate an all-optical chromatic dispersion compensation device at the input to an optical receiver and thus perform the dispersion compensation in the optical domain to present a “corrected” optical signal as an input to the photodetecting device.

The inclusion of optical-based chromatic dispersion compensation allows for a higher data rate to be used without introducing an unacceptable bit error rate; alternatively, the use of optical-based dispersion correction allows for the reach of a data communications network to be increased.

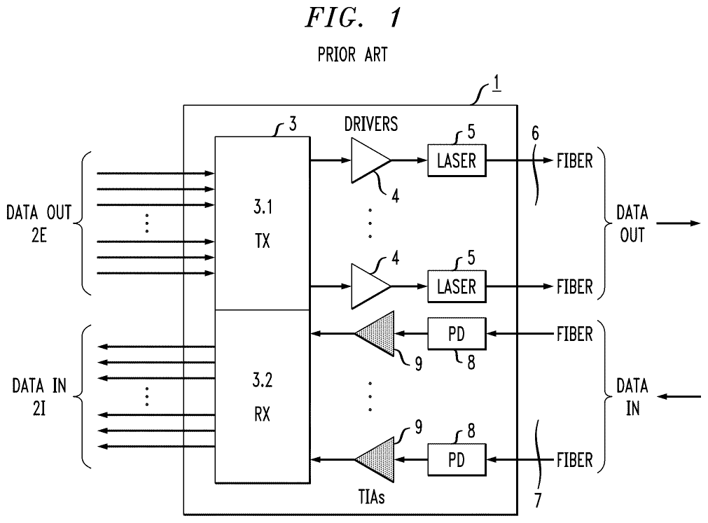

FIG. 1 is a simplified block diagram of a typical prior art optical transceiver 1 as used to support data communications within a short reach optical data network (for example, in the data center environment). In an exemplary data center application, the spacing (reach) between one transceiver and another may be on the order of about 500 meters. Describing the diagram of FIG. 1 from left to right, an electrical connections to optical transceiver 1 include a first grouping of electrical signal paths 2E (designated as the “egress” signal paths) and a second grouping of electrical signal paths 2I designated as the “ingress” electrical output signal paths. The electrical signal paths interface with an electrical communication module 3 of transceiver 1 that functions in a manner known in the art to perform the necessary encoding/decoding of signals passing through. In most architectures, the number of individual signal paths (referred to at times as “lanes”) is typically 4 or 8, or may be as high as 16.

A transmission encoder 3.1 receives the parallel data signal paths 2E and imparts a designated modulation format on these signals (e.g., NRZ, PAM4, PAM8, or the like). A set of parallel output signals from transmitter module 3.1 is shown, with each used to operate a separate driver circuit 4. Driver circuits 4 are used to energize an associated set of laser devices 5 to create a plurality of data-modulated optical output signals. The optical signals are coupled into optical fibers 6, which are used as the parallel data paths to another transceiver within the data center (or other short reach) environment.

In the reverse direction, a second set of fibers 7 is shown as coupled to transceiver 1 and in this case is used to introduce optical data signals from another transceiver into transceiver 1. A photodiode array 8 is used to convert these incoming, modulated optical signals into electrical current equivalents. An associated set of transimpedance amplifiers 9 is used to transform the electrical current signals into amplified voltages. As shown in prior art FIG. 1, the amplified voltage outputs are applied as parallel inputs to a receiver decoder 3.2 of electrical communication module 3. As mentioned above, module 3 is used in this direction to recover clock and data signals from the applied inputs, and pass them along the proper ingress signal paths 2I.

In order to provide higher and higher bandwidth (i.e., larger capacity) over this fixed number of signal paths (lanes), solutions typically involve the use of higher data rates and more complex modulation formats. As data rates continue to increase, the received optical signals may have accumulated enough chromatic dispersion to spread the pulse width and ultimately introduce error into the clock and data recovery process performed by module 3. Indeed, even in environments such as data centers that have relatively short reach, an increase in transmission capacity into the terabit range results in imparting a sufficient amount of dispersion on the received optical signals that some type of correction is required to accurately recover the transmitted data. Thus, it is proposed to incorporate optical-based chromatic dispersion compensation on the received optical signals prior to performing the O/E conversion in order ensure that accurate recovery of the transmitted data is maintained.

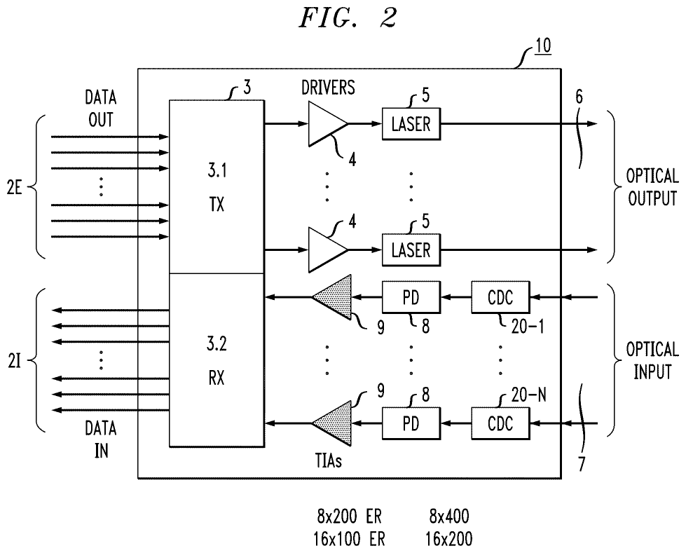

FIG. 2 is an exemplary optical transceiver 10 formed in accordance with the present disclosure to provide optical-based dispersion compensation at an optical receiver input. As shown, most of the components forming transceiver 10 are similar to those described above in association with prior art transceiver 1. Here, however, optical-based dispersion compensation is performed at the input to the receiver and is illustrates as a plurality of optical dispersion compensation elements 20 that are disposed at the input to the array of photodiode devices 8. In this particular embodiment, optical dispersion compensation elements 20 are associated with photodiode devices 8 in a one-to-one relationship that is illustrated here (for clarity purposes) as only showing optical dispersion compensation element 20-1 disposed at the input to photodiode 8-1, and optical dispersion compensation element 20-N disposed at the input to photodiode 8-N (where N is typically 4, 8, or 16).

Optical-based chromatic dispersion compensation elements 20 may comprise several different arrangements including, but not limited to, Gire-Tournois (GT) etalons (either air-gap or solid in form), ring resonators, or similar types of optical-based delay elements. The GT etalons and ring resonators may comprise single elements, or be formed as a cascaded plurality of similar units. For example, each GT etalon in an example dispersion compensation element 20 has an individual group delay response (as does each individual ring in a resonator configuration). The use of a plurality of individual delay devices in a cascaded arrangement will sum these individual group delays into an “aggregate” group delay, which is designed to introduce an inverse filtering effect on the received signal and essentially cancel out the accumulated chromatic dispersion. Advantageously, these all-optical types of chromatic dispersion compensation elements may be integrated with a photodetector array in a photonic integrated circuit and maintain a relatively compact configuration for the receiver.

By virtue of incorporating chromatic dispersion compensation at the input to the photodiodes, it is possible to extend the “reach” of a given link and/or increase the supported data rate, since possible reception errors attributed to the link's chromatic dispersion are mitigated prior to recovering the transmitted data. The optical chromatic dispersion compensation elements are relatively low cost (as opposed to the receiver electronics required for coherence-based systems) and can rely on the modulation technique of the transceiver.

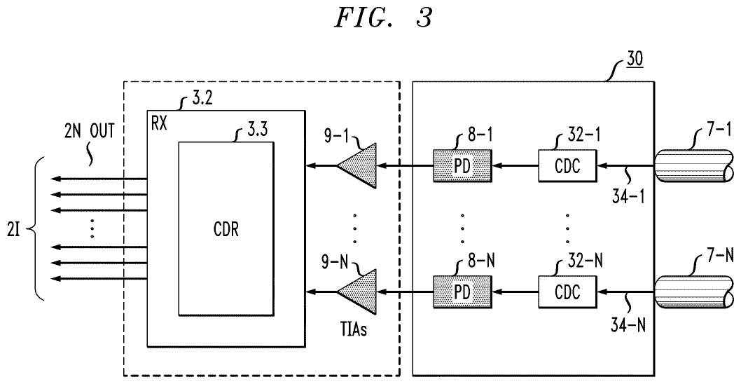

FIG. 3 illustrates an embodiment of a receiver based on the integration of chromatic dispersion compensation elements with photodiode array 8. In this particular embodiment, a plurality of individual chromatic dispersion compensation elements 32 are integrated in a common photonic integrated circuit 30 with photodiode array 8. Also shown is the plurality of incoming fibers 7, which in this integrated configuration is coupled to a like plurality of optical waveguides 34 formed within photonic integrated circuit 30. The “distorted” incoming optical signals propagating along waveguides 34 are first passed through their associated chromatic dispersion elements 32, which function to mitigate the effects of chromatic dispersion (which may otherwise result in inter-symbol interference, for example), and present these “corrected” optical signals as inputs to photodiodes 8. By virtue of applying optical compensation on the received optical signals, the converted electrical signals thereafter applied as inputs to transimpedance amplifiers 9 have very little distortion and may proceed into clock and data recovery (CDR) circuit 3.3 of receiver 3.2, which decodes the electrical signals to recover the transmitted data. The decoding is performed with a bit error rate (BER) well within industry standards, since the incoming optical signals have been corrected to compensate for chromatic dispersion.

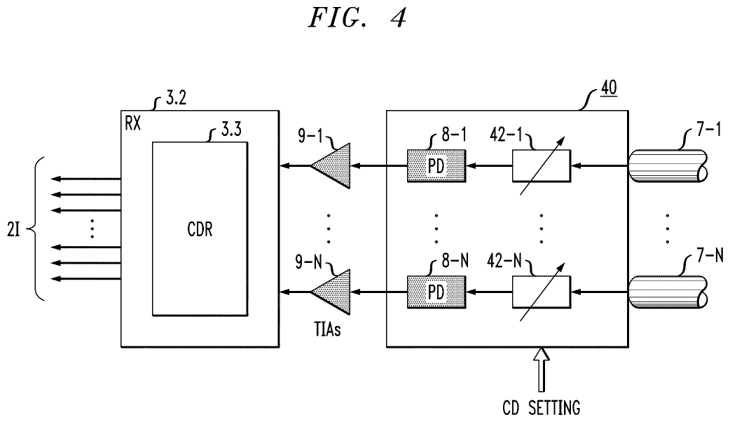

As mentioned above, the degree (level) of distortion imparted on the propagating optical signals is not only a function of the fiber path length along which the signal propagates (i.e., the “reach”), but the line rate used to encode the data signals in the first instance. Thus, the amount of dispersion compensation required to be performed by the all-optical chromatic dispersion element of this disclosure may differ as the line rate (and/or modulation format) changes. FIG. 4 illustrates another disclosed embodiment, where in this case a plurality of tunable chromatic dispersion elements 42 is integrated with photodiodes 8 within a photonic integrated circuit 40. An external control signal (which may be transmitted from a network management component, for example) may be used to adjust/tune the operation of dispersion compensation elements 42 based upon the known type of signaling format being used in a specific application. The tuning may be accomplished, for example, by the use changes in the ambient temperature of the dispersion compensators (thermal tuning), or by controlling the number of cascaded stages used to create the desired phase adjustment in the received optical signal.

Recall from the architecture of transceiver 10 of FIG. 2 that the incorporation of a plurality of N chromatic dispersion components 20-1 through 20-N may allow for the “reach” of a prior art transceiver to be extended, or for the line rate to be increased, where the latter is important for increasing the transmission capacity of short reach applications. For example, a conventional transceiver may include 16 egress electrical lanes 2E, forming a plurality of 8 separate lanes of modulated signals that are applied to 8 separate lasers. In the prior art, a modulation (data) rate of 100 Gb/s would be typically used, creating a capacity of 800 Gb/s. By virtue of incorporating optical-based dispersion compensation in accordance with the teachings of the present disclosure, the data rate may be doubled to 200 Gb/s, which thereby increases the transmission capacity to 1600 Gb/s. Indeed, the inclusion of the optical-based dispersion compensation may provide distortion correction for a received data signal operating at 400 Gb/s. Using this data rage with the “8 lane” arrangement of FIG. 2, a transmission capacity of 3200 Gb/s may be provided.

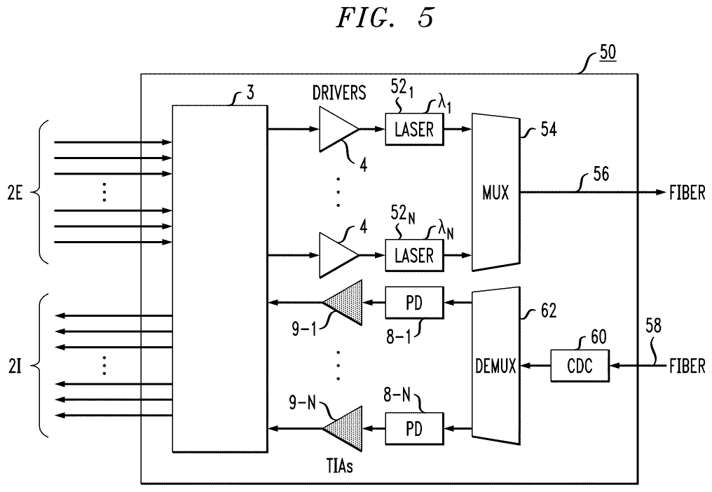

FIG. 5 illustrates another type of optical transceiver utilizing optical-based chromatic dispersion compensation on the received data signals in accordance with the disclosed In this model, a high data rate optical teachings.

transceiver 50 is configured to support data transmission on a plurality of N different wavelengths λ1 through λN. Transceiver 50 includes a plurality of N laser sources 52, each individual source set to operate at one of the selected wavelengths λ1 through λN. The plurality of N separate signal paths (each supporting propagation of a data signal at a different wavelength) are shown as applied as separate inputs to an optical wavelength division multiplexer (MUX) 54. In a conventional process well-known in the art, MUX 54 couples each of these individual signals into a single output fiber 56 that exits transceiver 50.

In looking at the receiver configuration for this multi-wavelength embodiment, all N incoming data signals will be propagating along a single input fiber 58, as shown in FIG. 50. In accordance with the principles of this disclosure, an optical chromatic dispersion compensator 60 is shown as coupled to input fiber 58 and used to provide compensation for the dispersion experienced by the data sent on each different wavelength. The single, multi-wavelength output from chromatic dispersion compensator 60 is thereafter applied as an input to a wavelength division demultiplexer (DEMUX), used to direct the optical data signals on each of the different wavelengths λ1 through λN into an associated photodiode 8-1 through 8-N. The ability to provide extended reach or increased signal capacity in this multi-wavelength transceiver 50 is similar to that discussed above in association with transceiver 10 of FIG. 2.

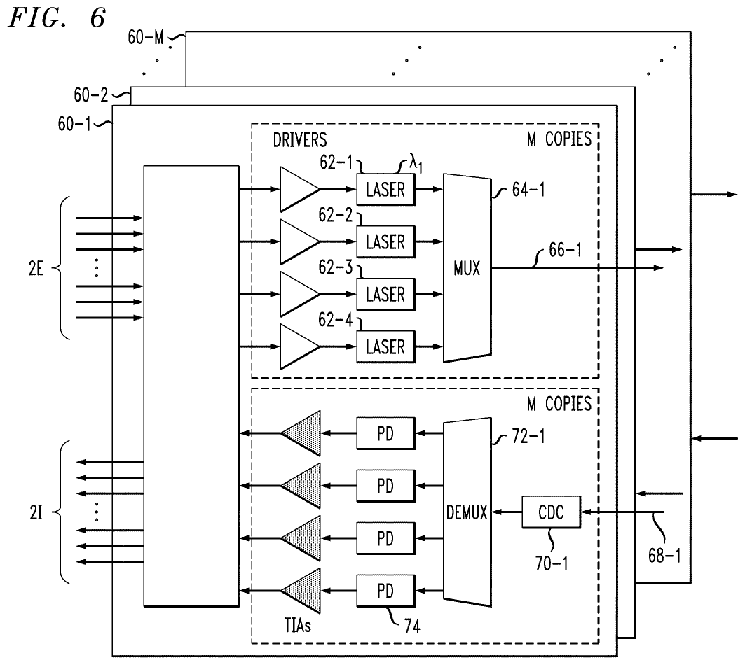

FIG. 6 illustrates yet another embodiment of an optical transceiver formed in accordance with the present disclosure, which utilizes the multi-wavelength feature described above in association with transceiver 50 of FIG. 5 in combination with an M-dimensional architecture. That is, the components shown within a transceiver 60-1 are replicated in additional transceiver modules to provide for increased transmission capacity. In the example of FIG. 6, a plurality of M individual transceiver units 60-i through 60-M included. In one embodiment, each transceiver 60-i may utilize a set of four lasers 62, each one operating at a different defined wavelength selected from the group λ₁, λ₂, λ₃, λ₄. As with multi-wavelength transceiver 50, each transceiver 60-i includes a MUX 64 to combine the four individual signals onto a common output fiber link 66.

M-dimensional, multi-wavelength transceiver 60 also receives a plurality of M multi-wavelength optical input signals, received on a plurality of M different input fibers 68 (fiber 68-1 of transceiver element 60-1 particularly shown in FIG. 6). As with the configuration of FIG. 5, the incoming multi-wavelength signal is first passed through its associated optical-based chromatic dispersion compensator 70-i. The “corrected” (compensated) multi-wavelength output from compensator 70-i is thereafter applied as an input to a DEMUX 72-i to be separated into the four individual wavelengths and directed into the appropriate photodiode.

Summarizing, embodiments of an optical transceiver (or optical receiver) suitable for use in data communications have been disclosed, integrating optical chromatic In dispersion compensation along the received signal input. light of need for continuing data rate increases in optical data communication networks (even if short link lengths remain), an optical-based chromatic dispersion device used to correct incoming distorted optical signals before reaching the converting photodetector is thought to enable much higher data rates and, if needed, extend the reach of a given data link. Line rates in excess of, for example, 100 Gb/s (“100 G”) are contemplated for use in these data communication application; indeed, various standards are currently being developed for line rates of 400 G. The integrated all-optical chromatic dispersion compensation of this disclosure is considered to be an important element of the optical receivers used in these applications.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are considered to be fully encompassed in scope by the claims appended hereto.

What is claimed is:

1. An optical receiver for use in a high data rate optical communication network, comprising:
an optical-based chromatic dispersion compensation element, responsive to an incoming optical data signal and configured to introduce optical phase delays sufficient to correct for fiber link-related chromatic dispersion;
a photodetector for converting the corrected optical data signal into an electrical equivalent; and
electronic receiver circuitry coupled to the output of the photodetector for recovering electrical clock and data signals from the corrected optical data signal input.

2. An optical receiver as defined in claim 1, wherein the optical-based chromatic dispersion compensation element comprises at least one GT etalon.

3. An optical receiver as defined in claim 2, wherein the at least one GT etalon comprises a cascaded plurality of individual GT etalon elements, each element introducing a group delay value to the phase delay, the cascaded plurality providing an aggregated group delay.

4. An optical receiver as defined in claim 1, wherein the optical-based chromatic dispersion compensation element comprises at least one optical ring resonator including a delay component within the ring.

5. An optical receiver as defined in claim 4, wherein the at least one ring resonator comprises a cascaded plurality of individual ring resonators, each ring resonator introducing a group delay value to the phase delay, the cascaded plurality providing an aggregated group delay.

6. An optical receiver component for use in high data rate optical transceiver, comprising:
a plurality of N parallel optical fibers, each optical fiber supporting transmission of a high data rate signal;
a plurality of N individual optical-based chromatic dispersion compensation elements, coupled to the plurality of N parallel optical fibers in a one-to-one relationship, each optical-based chromatic dispersion compensation element configured to impart a phase delay on the associated incoming optical signal sufficient to compensate for chromatic dispersion accumulated along the optical fiber;
a plurality of N photodetectors coupled to the plurality of N individual optical-based chromatic dispersion compensation elements in a one-to-one relationship, each photodetector for converting a chromatic dispersion-compensated optical data signal into an electrical equivalent; and
electronic receiver circuitry receiving as parallel inputs a plurality of N electrical equivalent signal and recovering therefrom recovered clock and data signals.

7. An optical receiver as defined in claim 6, wherein the optical-based chromatic dispersion compensation element comprises at least one GT etalon.

8. An optical receiver as defined in claim 7, wherein the at least one GT etalon comprises a cascaded plurality of individual GT etalon elements, each element introducing a group delay value to the phase delay, the cascaded plurality providing an aggregated group delay.

9. An optical receiver as defined in claim 6, wherein the optical-based chromatic dispersion compensation element comprises at least one optical ring resonator including a delay component within the ring.

10. An optical receiver as defined in claim 9, wherein the at least one ring resonator comprises a cascaded plurality of individual ring resonators, each ring resonator introducing a group delay value to the phase delay, the cascaded plurality providing an aggregated group delay.

11. An optical receiver component for use in multi-wavelength high data rate optical transceiver, comprising:
an incoming optical fibers supporting transmission of a plurality of N high data rate signals, each operating at a different optical wavelength;
an optical-based chromatic dispersion compensation element coupled to the incoming optical fiber and configured to impart a phase delay on the multi-wavelength incoming optical signal sufficient to compensate for chromatic dispersion accumulated along the optical fiber;
a wavelength division demultiplexer coupled to the output of the optical-based chromatic dispersion compensation element for separating the plurality of N high data rate signals and directing each high data rate signal along a separate signal path;
a plurality of N photodetectors, each photodetector receiving as an input a separate one of the plurality of N outputs from the wavelength division demultiplexer and converting the received, compensated optical data signal into an electrical equivalent;
electronic receiver circuitry receiving as parallel inputs a plurality of N electrical equivalent signal and recovering therefrom recovered clock and data signals.

12. An optical receiver as defined in claim 11, wherein the optical-based chromatic dispersion compensation element comprises at least one GT etalon.

13. An optical receiver as defined in claim 12, wherein the at least one GT etalon comprises a cascaded plurality of individual GT etalon elements, each element introducing a group delay value to the phase delay, the cascaded plurality providing an aggregated group delay.

14. An optical receiver as defined in claim 11, wherein the optical-based chromatic dispersion compensation element comprises at least one optical ring resonator including a delay component within the ring.

15. An optical receiver as defined in claim 14, wherein the at least one ring resonator comprises a cascaded plurality of individual ring resonators, each ring resonator introducing a group delay value to the phase delay, the cascaded plurality providing an aggregated group delay.
